(19) United States
(12) Patent Application Publication
(10) Pub. No.: US 2025/0392733 A1
(43) Pub. Date: Dec. 25, 2025

(54) SYSTEMS, METHODS, AND STORAGE MEDIA FOR TRANSMITTING MULTIPLE DATA STREAMS OVER A COMMUNICATIONS NETWORK FOR REMOTE INSPECTION

(71) Applicant: HARVEST TECHNOLOGY PTY LTD, Bentley, Western Australia (AU)

(72) Inventor: JARON WARBURTON, Bentley, Western Australia (AU)

(21) Appl. No.: 18/880,398

(22) PCT Filed: Jul. 14, 2023
(86) PCT No.: PCT/AU2023/050652

§ 371 Date: Dec. 31, 2024

(30) Foreign Application Priority Data
Jul. 14, 2022 (AU) 2022901970
Dec. 22, 2022 (AU) 2022903986

(51) Int. Cl. H04N 19/169; H04L 65/65; H04N 21/2365; H04N 21/242; H04N 21/61

(52) U.S. Cl. CPC H04N 19/169; H04L 65/65; H04N 21/2365; H04N 21/242; H04N 21/6143

(57) ABSTRACT

Systems, methods, and storage media for transmitting multiple data streams over a communications network for remote inspection are disclosed. Exemplary implementations may: preprocess a plurality of video streams into a single synchronized frame; encode the single synchronized frame; packetize the encoded single synchronized frame as a multiplexed packet for transmission with multiple multiplexed packets over the communications network; depacketize the multiplexed packet received over the communications network to produce the single synchronized frame; and decode the synchronized frame into the plurality of video streams for remote inspection.

### FIELD OF THE DISCLOSURE

The present disclosure relates to systems, methods, and storage media for transmitting multiple data streams over a communications network for remote inspection.

### BACKGROUND

Transmitting audio and/or video over communications networks for remote output is now commonplace, both for entertainment and business. Video and audio transmission has only become more important with remote work, and going forward, with the advances in automation or “robots.”

By way of example, work done on vessels offshore including everything from an exploratory submarine, to work on the deck and bridge of the mother vessel, can be automated by “robots.” Robots are not entirely automated, still needing to be monitored and at least partially controlled by people. The number of people on board the vessel to monitor and/or control the robots, however, can be greatly reduced and perhaps even altogether eliminated if those people can be terrestrially stationed and remotely monitor/control operations on board the vessel via video and/or audio that is transmitted back to the terrestrial control station or office.

### SUMMARY

One aspect of the present disclosure relates to a system configured for transmitting multiple data streams over a communications network for remote inspection. The system may include one or more hardware processors configured by machine-readable instructions. The processor(s) may be configured to preprocess a plurality of video streams into a single synchronized frame. The processor(s) may be configured to encode the single synchronized frame. The processor(s) may be configured to packetize the encoded single synchronized frame as a multiplexed packet for transmission with multiple multiplexed packets over the communications network. The processor(s) may be configured to depacketize the multiplexed packet received over the communications network to produce the single synchronized frame. The processor(s) may be configured to decode the synchronized frame into the plurality of video streams for remote inspection.

In some implementations of the system, the processor(s) may be configured to buffer the multiple multiplexed packets received over the communications network.

In some implementations of the system, the processor(s) may be configured to postprocess the buffered multiple multiplexed packets to produce a plurality of single synchronized frames for remote inspection.

In some implementations of the system, postprocessing may further include counting frames.

In some implementations of the system, postprocessing may further include synchronizing frames.

In some implementations of the system, the processor(s) may be configured to simultaneously display a plurality of channels on a single output device.

In some implementations of the system, the processor(s) may be configured to encrypt the multiplexed packet prior to transmission over the communications network. In some implementations of the system, the processor(s) may be configured to decrypt the multiplexed packet received over the communications network.

Another aspect of the present disclosure relates to a method for transmitting multiple data streams over a communications network for remote inspection. The method may include preprocessing a plurality of video streams from separate live video feeds at an operating location, the plurality of video streams preprocessed into a single synchronized frame for video data and a separate audio stream for audio data. The method may also include encoding the single synchronized frame. The method may also include packetizing the encoded single synchronized frame as a multiplexed packet for transmission with multiple multiplexed packets over the communications network to a monitoring location physically remote from the operating location. The method may also include depacketizing the multiplexed packet received over the communications network to produce the single synchronized frame. The method may also include decoding the synchronized frame into the plurality of video streams to display a plurality of channels on at least one output device for remote inspection at the monitoring location.

In some implementations of the method, it may include further including buffering the multiple multiplexed packets received over the communications network.

In some implementations of the method, it may include further including postprocessing the buffered multiple multiplexed packets to produce a plurality of single synchronized frames for remote inspection.

In some implementations of the method, postprocessing may further include counting frames.

In some implementations of the method, postprocessing may further include synchronizing frames.

In some implementations of the method, it may include further including simultaneously displaying a plurality of channels on a single output device.

In some implementations of the method, it may include further including encrypting the multiplexed packet prior to transmission over the communications network. In some implementations of the method, it may include and decrypting the multiplexed packet received over the communications network.

Yet another aspect of the present disclosure relates to a non-transient computer-readable storage medium having instructions embodied thereon, the instructions being executable by one or more processors to perform a method for transmitting multiple data streams over a communications network for remote inspection. The method may include preprocessing a plurality of video streams from separate live video feeds at an offshore operating location, the plurality of video streams preprocessed into audio data and video data. The method may include also encoding the video data into a single synchronized frame. The method may also include packetizing the encoded single synchronized frame as a multiplexed packet for transmission with multiple multiplexed packets over the satellite communications network to a terrestrial monitoring location physically remote from the operating location.

The method may also include transmitting the audio data as an audio stream separately from the video data. The method may also include depacketizing the multiplexed packet received over the satellite communications network to produce the single synchronized frame. The method may also include decoding the synchronized frame into the plurality of video streams to simultaneously display a plurality of channels on at least one output device for remote inspection at the terrestrial monitoring location

In some implementations of the computer-readable storage medium, the method may include further including buffering the multiple multiplexed packets received over the communications network.

In some implementations of the computer-readable storage medium, the method may include further including postprocessing the buffered multiple multiplexed packets to produce a plurality of single synchronized frames for remote inspection.

In some implementations of the computer-readable storage medium, postprocessing may further include counting frames.

In some implementations of the computer-readable storage medium, postprocessing may further include synchronizing frames.

In some implementations of the computer-readable storage medium, the method may include further including simultaneously displaying a plurality of channels on a single output device.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates an example of video and/or audio transmission via a communications network between a vessel and an onshore or terrestrial station, in accordance with one or more implementations.

FIG. 2 is a high-level block diagram of remote video and/or audio setup for transmission via a communications network, in accordance with one or more implementations.

FIGS. 3A and 3B illustrate a flowchart of example operations for remote video encoding, transmission via a communications network, and decoding of the transmitted video, in accordance with one or more implementations.

FIGS. 4A and 4B illustrate a flowchart of example operations for remote audio encoding, transmission via a communications network, and decoding of the transmitted audio, in accordance with one or more implementations.

FIG. 5 illustrates a system configured for transmitting multiple data streams over a communications network for remote inspection, in accordance with one or more implementations.

FIG. 6 illustrates a method for transmitting multiple data streams over a communications network for remote inspection, in accordance with one or more implementations.

### DETAILED DESCRIPTION

The present disclosure relates to transmitting multiple data streams over a communications network for remote inspection. In existing video and/or audio transmissions, multiple data streams are combined or “multiplexed” into packets for transmission over the communications network. For example, a four-camera system encodes four data streams into time-stamped packets for transmission. A decoder decodes the received time-stamped packets into separate video and/or audio streams. multiplexing incurs overhead which reduces the transmission efficiency and quality of the video and/or audio.

Implementations described herein address the aforementioned shortcomings and other shortcomings by providing a remote inspection system (RIS). The RIS includes a video processor which encodes multiple video and/or audio streams into a single synchronized frame, and then decodes the frame for remote inspection. For example, a four-camera system may read four buffers into a single synchronized quad frame without the need for timestamping. The quad frame has less overhead than traditional time-stamped packets. The frame can be transmitted in a single cycle, thereby increasing transmission efficiency and quality of the video and/or audio for remote inspection.

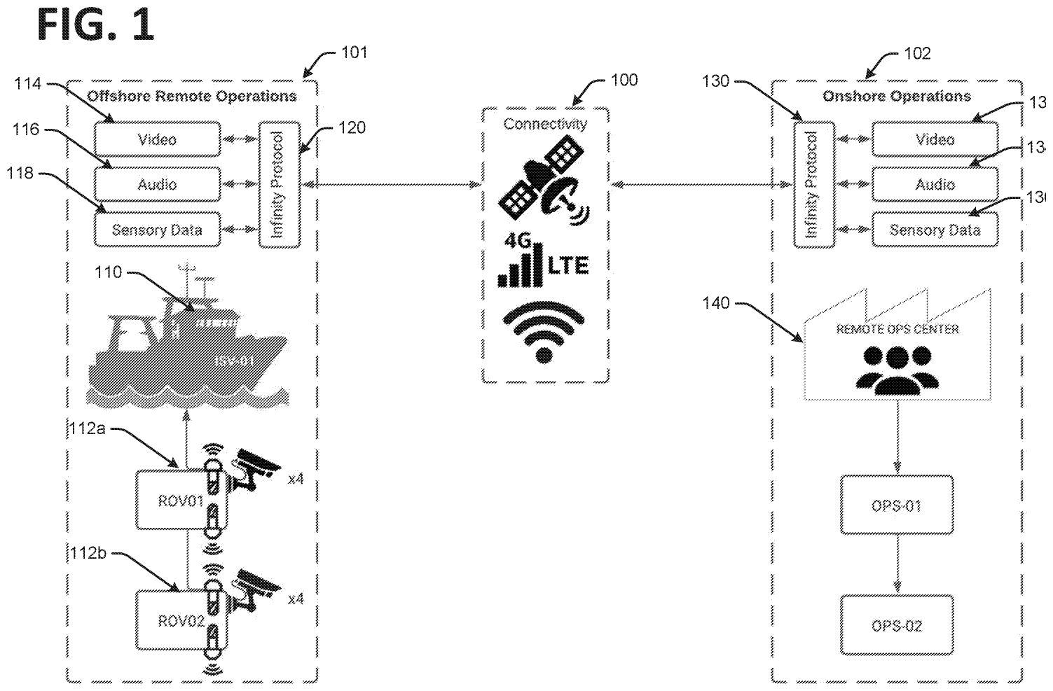

FIG. 1 illustrates an example of video and/or audio transmission via a communications network between a vessel and an onshore or terrestrial station, in accordance with one or more implementations. It is noted that the vessel and onshore or terrestrial station are merely illustrative of an operating environment and not intended to be limiting except to the extent that the operating environment is explicitly recited in the claims.

In this illustration, the techniques of video and/or audio transmission may be implemented via any suitable communications network 100, such as but not limited to satellite, mobile network (e.g., 3G, 4G, 5G, etc.), and/or the Internet. Offshore remote operations may include any operations on one or more vessel 110 (e.g., a research ship) and/or in connection with the vessel (e.g., by a research submarine). The offshore remote operations may include obtaining data (e.g., by cameras 112a, 112b). The data may include, but is not limited to video data, 114, audio data 116, and/or sensory data 118, which may be processed by processing electronics 120 and transmitted via the communications network 100 to the onshore operations 102.

Onshore operations 102 may include post processing the data transmitted from the offshore remote operations 101 via the communications network 100. Post processing may be by post processing electronics 130 to obtain data (e.g., video data 132, audio data 134, and/or sensory data 136) for analysis at the remote operations center 140. For example, the data may be analyzed by people reviewing audio and/or video feeds of work done on the ship 110 by robots, illustrated generally in FIG. 1 as ops-01 and ops-02.

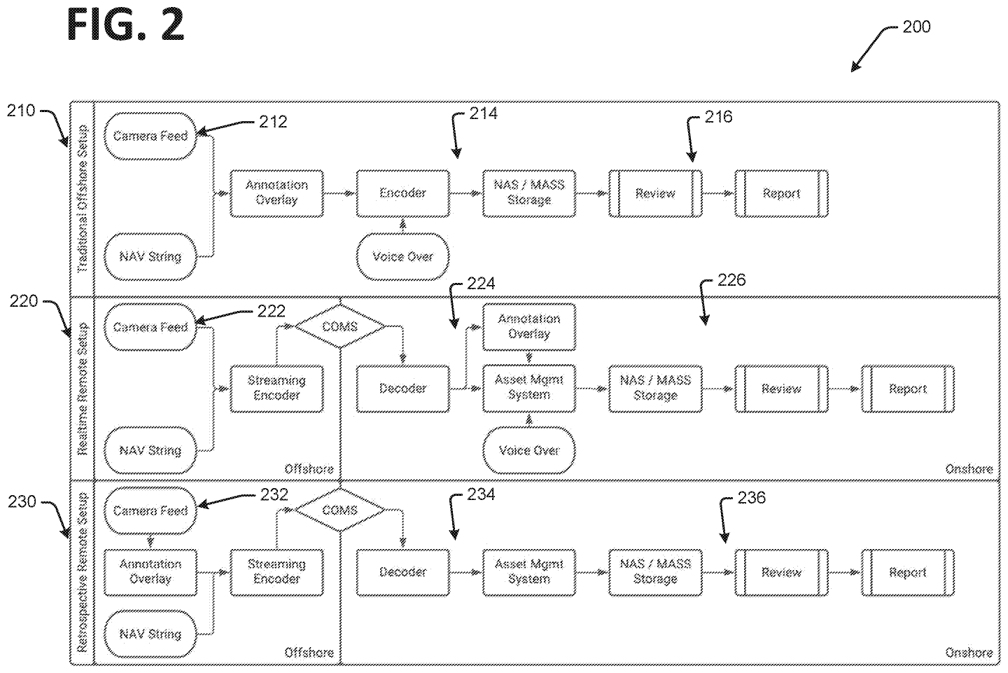

FIG. 2 is a high-level block diagram of remote video and/or audio setup 200 for transmission via a communications network, in accordance with one or more implementations. In FIG. 2, traditional offshore setup 210 may include receiving video data from a camera feed 212, processing the corresponding video data 214, followed by human review and/or reporting 216.

Remote video and/or audio setup 200 for transmission via a communications network is illustrated by real-time remote setup 220 and by retrospective remote setup 230. Real-time remote setup 220 may include receiving video data from a camera feed 222, processing the corresponding video data 224 according to the techniques described herein, followed by human review and/or reporting 226. Processing of the data may occur in real-time, e.g., as the video feed is obtained at the vessel. It is noted that in this example, processing the corresponding video data 224 may include preprocessing the data (e.g., at the vessel for transmission via the communication network) and then postprocessing the data (e.g., at the terrestrial station), thereby devolving the need for human interaction at the vessel.

Retrospective-time remote setup 230 may include receiving video data from a camera feed 232, processing the corresponding video data 234 according to the techniques described herein, followed by human review and/or reporting 236. Processing of the data may occur after the fact, e.g., at the end of the day or following an operation at the vessel. It is noted that in this example, processing the corresponding video data 234 may include preprocessing the data (e.g., at the vessel for transmission via the communication network) and then postprocessing the data (e.g., at the terrestrial station), thereby devolving the need for human interaction at the vessel.

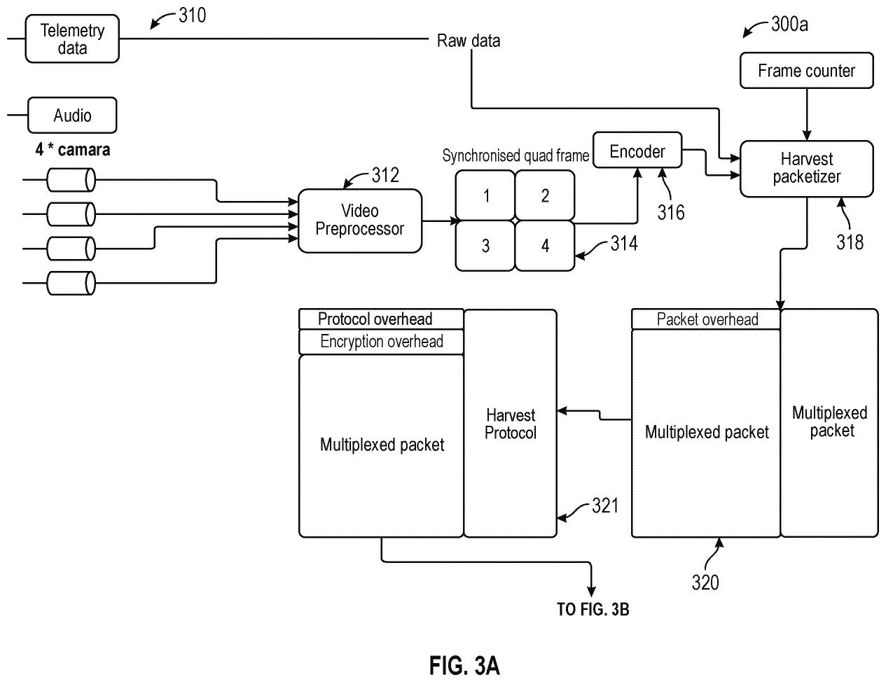

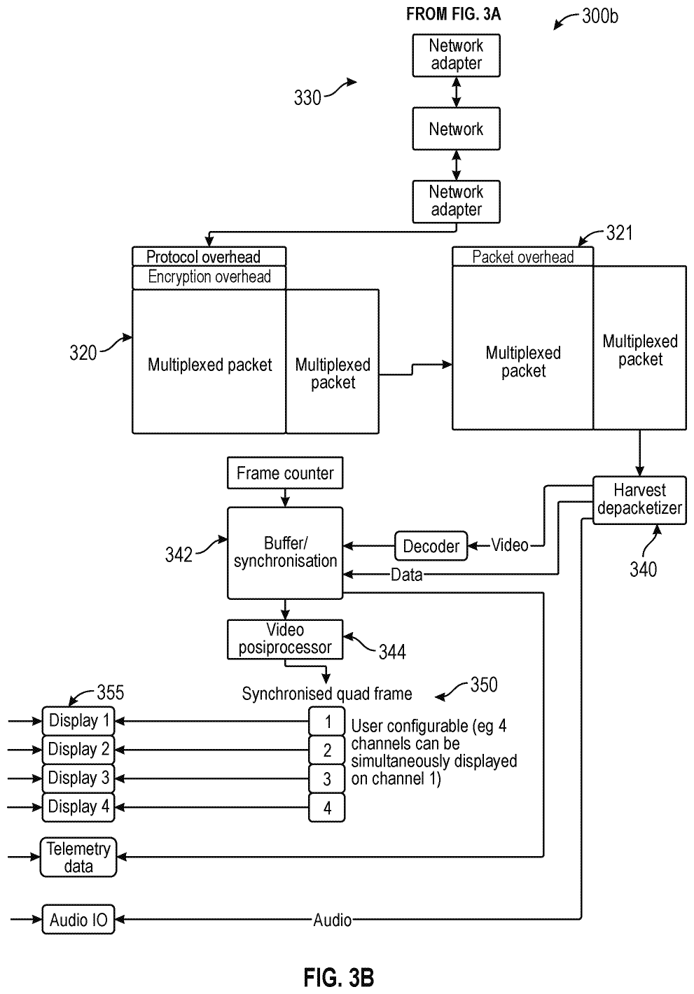

FIGS. 3A and 3B illustrate a flowchart of example operations 300a and 300b for remote video encoding, transmission via a communications network, and decoding of the transmitted video, in accordance with one or more implementations. It is noted that FIGS. 3A and 3B formed a combined flowchart and are not independent of one another.

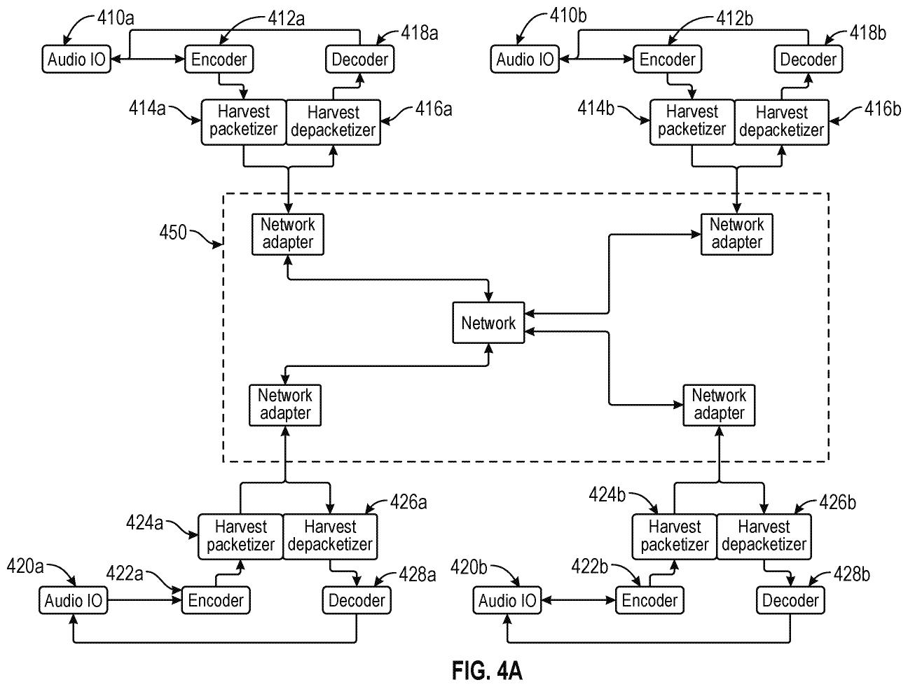

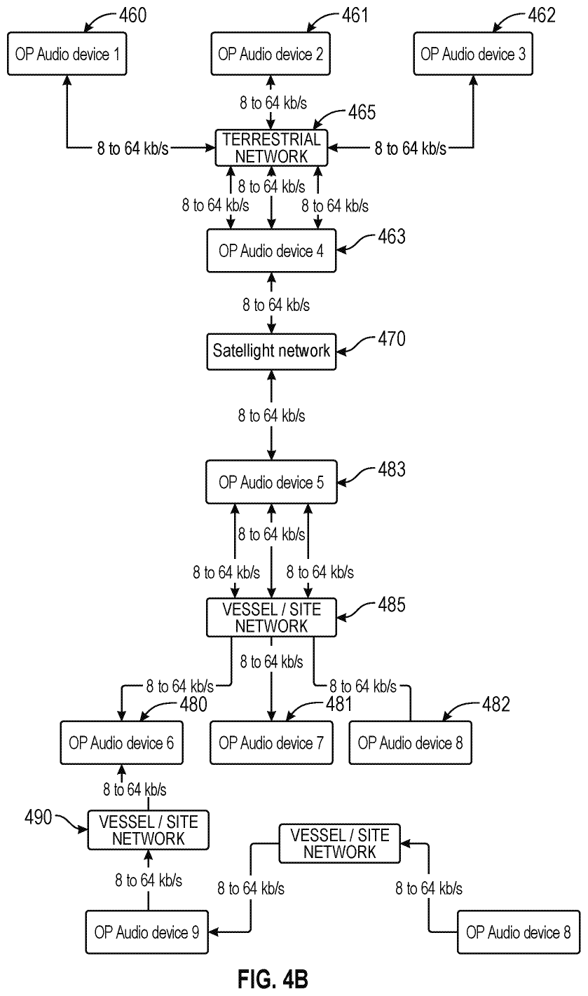

FIG. 3A illustrates data 310 generated at the remote site (e.g., the offshore worksite or vessel in FIG. 1). Example data 310 may include, but is not limited to, telemetry data, audio data, and raw video. Audio data processing is described below with reference to FIGS. 4A and 4B. In FIG. 3A, raw video is illustrated as 4 streams or channels of video data. The data is preprocessed by video processor 314, e.g., to generate a synchronized quad frame 314, which is then encoded 316 and packetized 318, as data packets 320, 321. Operations continue in FIG. 3B.

In FIG. 3B, the data packets 320, 321 are transmitted via the network 330. Data packets 320, 321 are depacketized 340, and decoded 342. In an example, the decoded data may be buffered. The video data is post processed 344 and output as a synchronized quad frame 350. In an example, the synchronized quad frame may be output as user configurable channels (e.g., 4 channels can be simultaneously displayed on a single channel) on output devices 355. Corresponding telemetry data and audio data may also be output for the end-users.

An example implementation of remote video encoding and transmission in accordance with one or more implementations includes the efficient compression of a number (1, 2, 3, 4, or more) input video streams by combining the separate images into a single frame, and then separating the single frame into the original number (e.g., 4) of images after transport. The technique enables efficient communication over data transport protocols where bandwidth may be limited. By way of illustration, limited bandwidth communication may be present to communication via satellite, as is often implemented between offshore stations (e.g., research vessels) and terrestrial onshore stations (e.g., a data processing center). It is noted that this illustration is not intended to be limiting in any regard.

In an example implementation, remote video encoding and transmission includes a data transmission protocol that combines a number (e.g., 4) video channels, and manipulates the video data to be issued over a network by combining and compressing the data packets for transport. In an example, the video channels include high definition video (e.g., 1080p) and formats the multiple video channels into a single frame (e.g., 4 k) for transmission over a limited bandwidth connection via a regular node stream encode/decode technique.

Telemetry data may also be provided for transmission. For example, data from depth sensors, inertial sensors, bearing, direction, cameras, testing sensors, may all be fed in through a NAV serial string along with the camera feeds. Audio data may also be included. For example, audio may include a live voiceover by an observer for what is inspected/commented on. Audio is discussed below in detail with reference to FIGS. 4A and 4B.

The NAV string is converted to a video overlay and encoded for transport and reassembly. For example, reassembly may be onshore for an inspection engineer generally based onshore. The data is passed into a streaming decoder, transmitted onshore, split out/decoded, and then the onshore workflow takes place to manage operations onshore. This procedure can be said to “mirror” conventional operation where everyone is present onboard. But instead of having to have everyone onboard, the remote video encoding and transmission procedure enables people to be stationed apart from the vessel (e.g., onshore).

It is noted that the remote video encoding and transmission techniques described herein may also be implemented to issue instructions back to the vessel, e.g., to personnel onboard the vessel and/or machinery or other devices (e.g., manipulating the cameras) to carry out further investigation into what the inspection engineer is seeing via the video feed. This may be particularly important where the technique is being implemented on a fully autonomous vessel.

Conventionally, video from a plurality of cameras, along with audio and telemetry data can be time-stamped and multiplexed into a packet. This typically includes combining the video, audio, and telemetry data, plus packet overhead and a timestamp, and then converting this into a new RTP or other format packet to transfer over a network, thereby adding yet another (e.g., RTP) layer to the packet. For example, a preprocessor with 4 encoders is required to run its own hardware, often time separated or unlinked from one another, each grabbing a separate frame from a separate camera. The packetized data is then received on the other end, and in reverse order, demultiplexer. That is the video is taken out of the packetized data and synchronized to each separate display. Each video is a single channel. Each encoder must have its own demultiplexer, and this process must be repeated each time (e.g., 4 times for 4 video feeds). The overhead is compounded at each step. While this may be acceptable if bandwidth is not an issue (e.g., for closed caption television or CCTV systems) over a closed local network, this technique requires too much overhead for transmission over remote transport communications networks (e.g., satellite).

Instead, the techniques described herein preprocess the video. All frames are taken in one cycle at a time, and timed with corresponding frames. Only one encoder is needed, so the time between a single threaded video all happens in the same CPU cycle(s). This is referred to herein as synchronous data capture.

It is noted that frame synchronous data, as the term “synchronous” is used herein means the data that arrives within a time limit. For example, all transmission systems (RSS, RS232 or UDP) are by definition asynchronous. That is, the chipset is asynchronous. But as used herein, the term “synchronous” means any data that arrives within a 16 millisecond time limit will be posted out with that frame. The frame output video on is the same as the data is received. This allows the system described herein to capture multiple telemetry data from different sources all at same time, and output all of it together with the corresponding video.

Turning again to the video preprocessing, in an example four 1080p frames may be combined into a single 4 k frame. Frames are copied to respective areas in a 4 k frame. By putting 4 frames into a single encoder, the technique removes 4 times the overhead versus a conventional system.

In addition, a full frame may be used as a reference, exploiting how encoders work. That is, if a single 1080 video is input into an encoder, parts of that video may be used to reference other parts of the video in subsequent frames. By way of illustration, if an orange circle disappears in frame 30, and then reappears in frame 35, that orange circle need not be resent. Instead, it can be referenced. A single frame may reference a frame that can be used in subsequent frames. Up to 4 frames may be referenced for any other frame. For example, if camera 1 has an orange dot, and camera 4 has that same orange dot at frame 35, the video from camera 4 does not need to be sent.

Whether to transmit or reference a frame algorithm can be executed by the encoder hardware. In an example, all of the frames can spread data on the same encoder, so it can represent frames from other cameras as one picture. Parts of the camera video (e.g., camera 4) can be used in preceding frames to build data for another camera (e.g., camera 1).

In an example implementation, remote video encoding and transmission includes video handling. During video handling, scaling of the video stream(s) happens on the way out of the camera into the preprocessor. The decoder references each frame as it is received. The encoder tuner may also assess motion, reference to previous frames, etc. to determine the best output for the lowest bitrate and optimize the video based on input feeds. It is noted that this process is more efficient than 4 separate feeds. Instead, the data is packetized with only 1 descriptor (not 4, as in the prior art).

To further enhance transmission efficiencies, the control system may allow the user to focus on any one or up to all of the video streams. If the user is only viewing a single channel (or two channels, etc.), then the system only sends the channel(s) being viewed.

In an example implementation, remote video encoding and transmission includes a new packetizer. A multiplexer is not necessary to squeeze all formats into a single packet. Instead, the video packet is separate from the audio packet, which is separate from the data packet. There are only two headers.

When the video packet is received (e.g., onshore), it can be split back out into separate streams so that the user can view any of the video streams on any output device with only a single instance of decoding. The remote video encoding and transmission technique includes counting frames at both ends so that the system knows how many frames went in and are coming out, as referenced in the packet in case the packets are received out of sync. The packets are, read into a sync buffer and timed with frame. Any gap in time between when full payload of video data and when empty payload is accounted for, so that there is enough time to send telemetry data, thus preventing a packet 90% overhead. Indeed, every packet has overhead, so it is more efficient if every packet is as full as possible.

In an example, telemetry and video are sent separately. This also has the benefit of maintaining a constant (or nearly constant) bitrate over time. The same (or substantially the same) size packets are being sent, rather than bursting. Sending telemetry data during troughs helps to maintain a constant baseline bitrate, which is preferred, for example, in satellite communications which do not function as well with variable bitrates.

In an example implementation, remote video encoding and transmission includes processing packets at the end (e.g., onshore) at the same rate that the packets are coming in. In an example, the user can speed up or slow down the output. The system may buffer packets for consistent playback.

It is noted that the encoder may also include temporal analysis (e.g., areas of interest within a video segment). In an example, the temporal analysis is expanded to the edges of the frame so that areas of interest are the full frame. The encoder can then assess the full frame rather and render the outer edges. The temporal part of encoder also drops the bit rate substantially, further reducing the packet size that needs to be transmitted.

FIGS. 4A and 4B illustrate a flowchart of example operations for remote audio encoding, transmission via a communications network, and decoding of the transmitted audio, in accordance with one or more implementations. In the remote inspection industry, the focus shifts into two groups. Group 1 requires the lowest possible latency communication, and Group 2 requires the highest quality and reliable video transmission for onshore telemetry data and video synchronization. With this in mind, we split the audio and visual data synchronization to provide a technical limit audio communications system, and a reliable video with synchronized data delivery system. The audio system differs from other communications systems. In conventional IP telephony networks, all participants both send and receive data from all other participants. Therefore, the bandwidth requirement is quickly compounded and this approach is not viable for large groups transmitting over satellite. The techniques disclosed herein mix audio at each group point and therefore only transmits the equivalent of one participant to downstream groups.

In an example implementation, remote video encoding and transmission includes splitting the audio. That is, the audio need not be timed to the video for transmission. The audio portion may be processed by a separate encoder than the encoder processing video. For example, the audio on the vessel bridge, audio in a submarine, audio in an inspection room, etc. may all have a separate audio device. If these are implemented as individual VOIP servers, there would be audio traffic from each of these with everyone getting everyone else's data (known as polycasting). In order to reduce transmission size (e.g., for a satellite link), separate audio devices on the offshore vessel can be linked to one device, also on the vessel. The system downlinks all audio into a single stream or audio packet. This is inversed onshore. The audio may be daisy chained or multiplexed audio coming in.

In the example shown in FIG. 4A, a two-way audio network 400 sends/receives audio corresponding to one or more video stream. For example, two-way audio IO 410a and 410b originating at one site (e.g., the vessel) may be encoded 412a, 412b and packetized 414a, 414b before being transmitted via the communications network 450.

The two-way audio IO 410a and 410b received at the other site (e.g., the terrestrial analysis site) from the first site (e.g., the vessel) may be depacketized 426a, 426b and decoded 428a, 428b after being received via the communications network 450.

The two-way audio IO 420a and 420b originating at the other site (e.g., the terrestrial analysis site) may be encoded 422a, 422b and packetized 424a, 424b at the terrestrial analysis site before being transmitted via the communications network 450.

The two-way audio IO 420a and 420b received at the one site (e.g., the vessel) from the other site (e.g., the terrestrial analysis site) may be depacketized 416a, 416b and decoded 418a, 418b after being received via the communications network 450.

FIG. 4B illustrates combining audio from multiple audio devices 460, 461, 462 at a terrestrial network 465 by a single audio device 463 and transmitting the combined audio via the communications network 470. The audio is received by the audio device 483 at the vessel network 485 and split to the respective audio devices 480, 481, and 482.

FIG. 4B also illustrates two-way audio communications, including combining audio from multiple audio devices 480, 481, 482 at the vessel network 485 by a single audio device 483 and transmitting the combined audio via the communications network 470. The audio is received by the audio device 463 at the terrestrial network 465 and split to the respective audio devices 460, 461, and 462. FIG. 4B also illustrates daisy chaining audio devices 490.

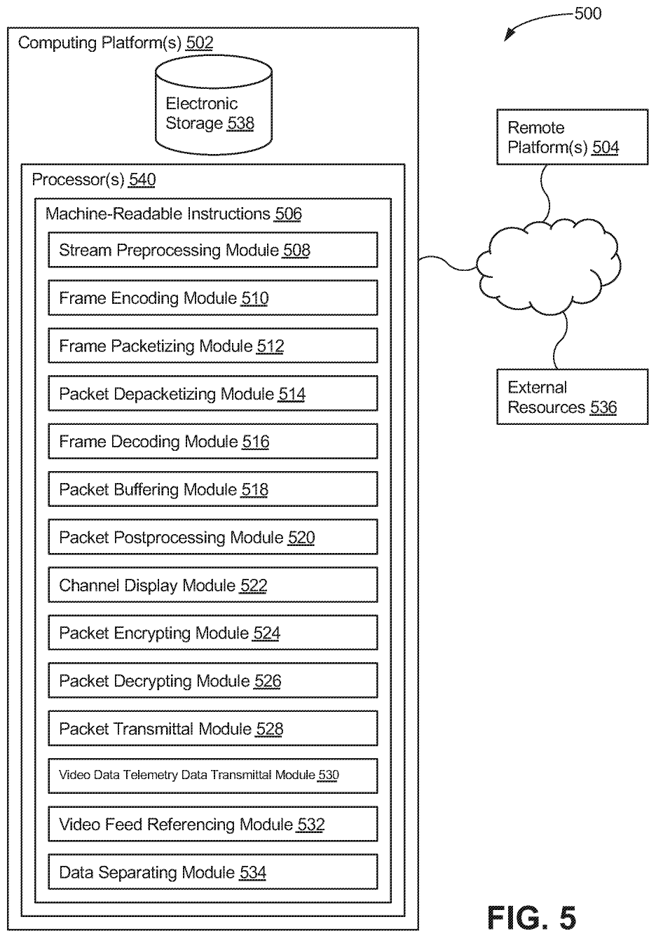

FIG. 5 illustrates a system 500 configured for transmitting multiple data streams over a communications network for remote inspection, in accordance with one or more implementations. In some implementations, system 500 may include one or more computing platforms 502. Computing platform(s) 502 may be configured to communicate with one or more remote platforms 504 according to a client/server architecture, a peer-to-peer architecture, and/or other architectures. Remote platform(s) 504 may be configured to communicate with other remote platforms via computing platform(s) 502 and/or according to a client/server architecture, a peer-to-peer architecture, and/or other architectures. Users may access system 500 via remote platform(s) 504.

Computing platform(s) 502 may be configured by machine-readable instructions 506. Machine-readable instructions 506 may include one or more instruction modules. The instruction modules may include computer program modules. The instruction modules may include one or more of stream preprocessing module 508, frame encoding module 510, frame packetizing module 512, packet depacketizing module 514, frame decoding module 516, packet buffering module 518, packet postprocessing module 520, channel display module 522, packet encrypting module 524, packet decrypting module 526, packet transmittal module 528, video data telemetry data transmittal module 530, video feed referencing module 532, data separating module 534, and/or other instruction modules.

Stream preprocessing module 508 may be configured to preprocess a plurality of video streams into a single synchronized frame. The term “video stream” as used herein refers to video images which are captured electronically via a video camera for delivery and consumption in a continuous manner. A “synchronized frame” refers to a data structure which includes video data from multiple video streams synchronized in time with one another. In other words, video taken at the same time T from multiple sources may be assembled in the data structure to correspond with one another for the time T. Preprocessing the plurality of video streams may include reading four buffers from four video channels into a single 4K quad frame. 1 video feed may occupy all 4 channels of the single 4K quad frame.

Frame encoding module 510 may be configured to encode the single synchronized frame.

Frame packetizing module 512 may be configured to packetize the encoded single synchronized frame as a multiplexed packet for transmission with multiple multiplexed packets over the communications network. The term “multiplexed packet” as used herein refers to multiple data packets or other electronic signals representing data which are transmitted substantially simultaneously with one another on a single channel of communication. The term “communications network” as used herein refers to any electronic communications network for transmitting/receiving data in electronic format. Illustrative communications networks include, but are not limited to telephone, 3G, 4G and 5G data networks (and future mobile data networks), satellite communications networks, and the Internet.

Packet depacketizing module 514 may be configured to depacketize the multiplexed packet received over the communications network to produce the single synchronized frame.

Frame decoding module 516 may be configured to decode the synchronized frame into the plurality of video streams for remote inspection. The term “remote inspection” as the term is used herein refers to viewing and/or listening to video and/or audio data at a physically remote location from the location where the video and/or audio data is captured. While the term “inspection” may refer to human inspection, the term is not limited to only human inspection and may also include human-assisted and/or fully automated techniques for inspection.

Packet buffering module 518 may be configured to buffer the multiple multiplexed packets received over the communications network.

Packet postprocessing module 520 may be configured to postprocess the buffered multiple multiplexed packets to produce a plurality of single synchronized frames for remote inspection.

Channel display module 522 may be configured to simultaneously display a plurality of channels on a single output device. It is noted that any output device may be implemented, for example, a computer monitor and/or other display and/or audio device for rendering the video and/or audio data. The term “single” as used herein to refer to an output device means one device, although the one device may be separated into multiple components such as separate video viewing areas on a single computer monitor.

Packet encrypting module 524 may be configured to encrypt the multiplexed packet prior to transmission over the communications network.

Packet decrypting module 526 may be configured to decrypt the multiplexed packet received over the communications network.

Packet transmittal module 528 may be configured to transmit all of the multiplexed packets over the communications network in a single cycle. Data is typically transmitted through a computer network along a series of nodes. Multiple data packets belonging together may be transmitted across any number of nodes (i.e., the network path) in the communications network, and then reassembled at their destination regardless of the network path. Data that is transmitted together across the same nodes is said to be transmitted in the same cycle or during a “single cycle” as the term is used herein.

Video data telemetry data transmittal module 530 may be configured to transmit video data and telemetry data separately over the communications network. The term “telemetry data” refers to data that is collected at multiple points and automatically transmitted to one or more receiving devices for monitoring. The term “video data” as the term is used herein refers to data (e.g., image data) corresponding to a video stream as that term has already been defined herein. The video data may represent a portion or an entirety of a video stream.

Video feed referencing module 532 may be configured to reference one video feed at the decoder and not resending the feed. The term “decoder” as used herein refers to program code and/or electronics configured to convert encoded data (e.g., video data) into a format that is readable by an endpoint (e.g., for output on a display device).

Data separating module 534 may be configured to separate audio data from video data for separate transmission over the communications network. The term “audio data” as the term is used herein refers to data representing sound waves and corresponding to an audio stream. The audio data may represent a portion or an entirety of an audio stream. It is noted that the audio data may be separately packetized and/or otherwise preprocessed for transmission apart from the video data. For example, the video data may be transmitted on peaks and the audio data may be transmitted in troughs. The audio data from all of the audio input devices may be transmitted over the communications network as individual 64 k blocks of audio data. Any suitable audio input devices may be implemented, such as a microphone or other device for receiving sound waves and digitizing the sound waves (e.g., as analog and/or digital signals) for transmission via the communication network. It is noted that the audio data may be transmitted via any suitable size data block and is not limited to 64 k blocks.

In some implementations, postprocessing may further include counting frames. In some implementations, postprocessing may further include synchronizing frames. In some implementations, the telemetry data may be transmitted separately on troughs, to maintain a substantially constant bit rate during transmission over the communications network. The term “trough” is well understood in electronics communications to mean a point or points in a cycle or signal having a minimum amplitude. The term “bit rate” as used herein refers to the number of bits per second that can be transmitted in the communications network. The transmission is not limited to a bit rate. In some implementations, all audio input devices may be linked through a single audio device for transmission of audio data from all of the audio input devices as a single stream over the communications network. The term “single” as used herein means one or separate and distinct unit. In some implementations, at least some of the audio input devices may be daisy chained together and feed into the single audio device.

In an example implementation, remote video encoding and transmission includes utilizing different protocols. For example, the encoder may implement its own packeting protocol to determine how data is sent, and select from standard transmission protocols. Standard protocols may include, but are not limited to, UDT, UDP, SRT SRT UDP/FEC.

In another example, the system may implement a unique protocol that removes overhead. It is noted that the term protocol as used herein refers to different layers, e.g., going up from a physical layer, to transport, and presentation layers. The new protocol encompasses techniques for latency, and other parameters defined in the transport layer. This enables the flexibility to send files, data, video, audio, etc. In addition, the protocol may send packets in a real time mode wherein data integrity is important, but after time that importance decreases (e.g., eventually to zero). The protocol may also set the importance (e.g., to zero). This may aid in removing as much packet overhead as possible and enables communication between end points regarding the status of data equality through minimal messages.

In an example implementation, remote video encoding and transmission includes an appliance application or “app” (e.g., for a tablet device). The app may display or show the user the various encoders, decoders, video streams, audio systems, etc. that are available for a particular installation. The user may draw connections between the devices and other components (e.g., video streams). For example, the user may draw a connection between an encoder and a decoder and the audio that has to pass through. The app may display or show the user where the audio can and can't go. This enables the user to sort audio to relevant people up the chain of command.

In a typical use case, the user may draw connections for an installation when starting a job. The user can adjust parameters such as bit rates and latencies based on network quality without having to go to the actual physical equipment to set it up, thereby providing the user with central control. This may be particularly useful, e.g., when equipment is located on racks (and even equipment on racks behind racks or other difficult places to reach).

In some implementations, computing platform(s) 502, remote platform(s) 504, and/or external resources 536 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 502, remote platform(s) 504, and/or external resources 536 may be operatively linked via some other communication media.

A given remote platform 504 may include one or more processors configured to execute computer program modules. The computer program modules may be configured to enable an expert or user associated with the given remote platform 504 to interface with system 500 and/or external resources 536, and/or provide other functionality attributed herein to remote platform(s) 504. By way of non-limiting example, a given remote platform 504 and/or a given computing platform 502 may include one or more of a server, a desktop computer, a laptop computer, a handheld computer, a tablet computing platform, a NetBook, a Smartphone, a gaming console, and/or other computing platforms.

External resources 536 may include sources of information outside of system 500, external entities participating with system 500, and/or other resources. In some implementations, some or all of the functionality attributed herein to external resources 536 may be provided by resources included in system 500.

Computing platform(s) 502 may include electronic storage 538, one or more processors 540, and/or other components. Computing platform(s) 502 may include communication lines, or ports to enable the exchange of information with a network and/or other computing platforms. Illustration of computing platform(s) 502 in FIG. 5 is not intended to be limiting. Computing platform(s) 502 may include a plurality of hardware, software, and/or firmware components operating together to provide the functionality attributed herein to computing platform(s) 502. For example, computing platform(s) 502 may be implemented by a cloud of computing platforms operating together as computing platform(s) 502.

Electronic storage 538 may comprise non-transitory storage media that electronically stores information. The electronic storage media of electronic storage 538 may include one or both of system storage that is provided integrally (i.e., substantially non-removable) with computing platform(s) 502 and/or removable storage that is removably connectable to computing platform(s) 502 via, for example, a port (e.g., a USB port, a firewire port, etc.) or a drive (e.g., a disk drive, etc.). Electronic storage 538 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 538 may include one or more virtual storage resources (e.g., cloud storage, a virtual private network, and/or other virtual storage resources). Electronic storage 538 may store software algorithms, information determined by processor(s) 540, information received from computing platform(s) 502, information received from remote platform(s) 504, and/or other information that enables computing platform(s) 502 to function as described herein.

Processor(s) 540 may be configured to provide information processing capabilities in computing platform(s) 502. As such, processor(s) 540 may include one or more of a digital processor, an analog processor, a digital circuit designed to process information, an analog circuit designed to process information, a state machine, and/or other mechanisms for electronically processing information. Although processor(s) 540 is shown in FIG. 5 as a single entity, this is for illustrative purposes only. In some implementations, processor(s) 540 may include a plurality of processing units. These processing units may be physically located within the same device, or processor(s) 540 may represent processing functionality of a plurality of devices operating in coordination. Processor(s) 540 may be configured to execute modules 508, 510, 512, 514, 516, 518, 520, 522, 524, 526, 528, 530, 532, and/or 534, and/or other modules. Processor(s) 540 may be configured to execute modules 508, 510, 512, 514, 516, 518, 520, 522, 524, 526, 528, 530, 532, and/or 534, and/or other modules by software; hardware; firmware; some combination of software, hardware, and/or firmware; and/or other mechanisms for configuring processing capabilities on processor(s) 540. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 508, 510, 512, 514, 516, 518, 520, 522, 524, 526, 528, 530, 532, and/or 534 are illustrated in FIG. 5 as being implemented within a single processing unit, in implementations in which processor(s) 540 includes multiple processing units, one or more of modules 508, 510, 512, 514, 516, 518, 520, 522, 524, 526, 528, 530, 532, and/or 534 may be implemented remotely from the other modules. The description of the functionality provided by the different modules 508, 510, 512, 514, 516, 518, 520, 522, 524, 526, 528, 530, 532, and/or 534 described below is for illustrative purposes, and is not intended to be limiting, as any of modules 508, 510, 512, 514, 516, 518, 520, 522, 524, 526, 528, 530, 532, and/or 534 may provide more or less functionality than is described. For example, one or more of modules 508, 510, 512, 514, 516, 518, 520, 522, 524, 526, 528, 530, 532, and/or 534 may be eliminated, and some or all of its functionality may be provided by other ones of modules 508, 510, 512, 514, 516, 518, 520, 522, 524, 526, 528, 530, 532, and/or 534. As another example, processor(s) 540 may be configured to execute one or more additional modules that may perform some or all of the functionality attributed below to one of modules 508, 510, 512, 514, 516, 518, 520, 522, 524, 526, 528, 530, 532, and/or 534.

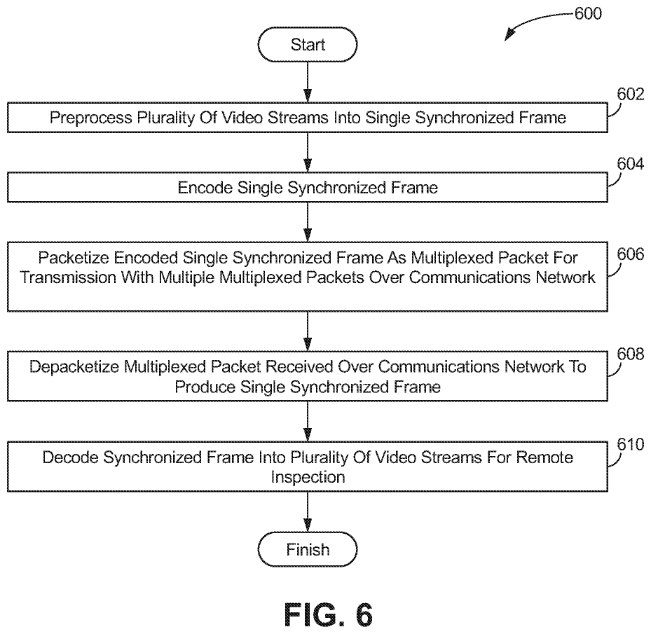

FIG. 6 illustrates a method 600 for transmitting multiple data streams over a communications network for remote inspection, in accordance with one or more implementations. The operations of method 600 presented below are intended to be illustrative. In some implementations, method 600 may be accomplished with one or more additional operations not described, and/or without one or more of the operations discussed. Additionally, the order in which the operations of method 600 are illustrated in FIG. 6 and described below is not intended to be limiting.

In some implementations, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

An operation 602 may include preprocessing a plurality of video streams into a single synchronized frame. Operation 602 may be performed by one or more hardware processors configured by machine-readable instructions including a module that is the same as or similar to stream preprocessing module 508, in accordance with one or more implementations.

An operation 604 may include encoding the single synchronized frame. Operation 604 may be performed by one or more hardware processors configured by machine-readable instructions including a module that is the same as or similar to frame encoding module 510, in accordance with one or more implementations.

An operation 606 may include packetizing the encoded single synchronized frame as a multiplexed packet for transmission with multiple multiplexed packets over the communications network. Operation 606 may be performed by one or more hardware processors configured by machine-readable instructions including a module that is the same as or similar to frame packetizing module 512, in accordance with one or more implementations.

An operation 608 may include depacketizing the multiplexed packet received over the communications network to produce the single synchronized frame. Operation 608 may be performed by one or more hardware processors configured by machine-readable instructions including a module that is the same as or similar to packet depacketizing module 514, in accordance with one or more implementations.

An operation 610 may include decoding the synchronized frame into the plurality of video streams for remote inspection. Operation 610 may be performed by one or more hardware processors configured by machine-readable instructions including a module that is the same as or similar to frame decoding module 516, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for transmitting multiple data streams over a communications network for remote inspection, the system comprising:
one or more hardware processors configured by machine-readable instructions to:
preprocess a plurality of video streams into a single synchronized frame;
encode the single synchronized frame;
packetize the encoded single synchronized frame as a multiplexed packet for transmission with multiple multiplexed packets over the communications network;
depacketize the multiplexed packet received over the communications network to produce the single synchronized frame; and
decode the synchronized frame into the plurality of video streams for remote inspection.

2. The system of claim 1, wherein the one or more hardware processors are further configured by machine-readable instructions to buffer the multiple multiplexed packets received over the communications network.

3. The system of claim 2, wherein the one or more hardware processors are further configured by machine-readable instructions to postprocess the buffered multiple multiplexed packets to produce a plurality of single synchronized frames for remote inspection.

4. The system of claim 3, wherein postprocessing further comprises counting frames.

5. The system of claim 3, wherein postprocessing further comprises synchronizing frames.

6. The system of claim 1, wherein the one or more hardware processors are further configured by machine-readable instructions to simultaneously display a plurality of channels on a single output device.

7. The system of claim 1, wherein the one or more hardware processors are further configured by machine-readable instructions to encrypt the multiplexed packet prior to transmission over the communications network;
wherein the one or more hardware processors are further configured by machine-readable instructions to decrypt the multiplexed packet received over the communications network.

8. A method for transmitting multiple data streams over a communications network for remote inspection, the method comprising:
preprocessing a plurality of video streams from separate live video feeds at an operating location, the plurality of video streams preprocessed into a single synchronized frame for video data and a separate audio stream for audio data;
encoding the single synchronized frame;
packetizing the encoded single synchronized frame as a multiplexed packet for transmission with multiple multiplexed packets over the communications network to a monitoring location physically remote from the operating location;
depacketizing the multiplexed packet received over the communications network to produce the single synchronized frame; and
decoding the synchronized frame into the plurality of video streams to display a plurality of channels on at least one output device for remote inspection at the monitoring location.

9. The method of claim 8, further comprising buffering the multiple multiplexed packets received over the communications network.

10. The method of claim 9, further comprising postprocessing the buffered multiple multiplexed packets to produce a plurality of single synchronized frames for remote inspection.

11. The method of claim 10, wherein postprocessing further comprises counting frames.

12. The method of claim 10, wherein postprocessing further comprises synchronizing frames.

13. The method of claim 8, further comprising simultaneously displaying a plurality of channels on the single output device.

14. The method of claim 8, further comprising encrypting the multiplexed packet prior to transmission over the communications network,
and decrypting the multiplexed packet received over the communications network.

15. A non-transient computer-readable storage medium having instructions embodied thereon, the instructions being executable by one or more processors to perform a method for transmitting multiple data streams over a satellite communications network for remote inspection, the method comprising:
preprocessing a plurality of video streams from separate live video feeds at an offshore operating location, the plurality of video streams preprocessed into audio data and video data;
encoding the video data into a single synchronized frame;
packetizing the encoded single synchronized frame as a multiplexed packet for transmission with multiple multiplexed packets over the satellite communications network to a terrestrial monitoring location physically remote from the operating location;
transmitting the audio data as an audio stream separately from the video data;
depacketizing the multiplexed packet received over the satellite communications network to produce the single synchronized frame; and
decoding the synchronized frame into the plurality of video streams to simultaneously display a plurality of channels on at least one output device for remote inspection at the terrestrial monitoring location.

16. The computer-readable storage medium of claim 15, wherein the method further comprises buffering the multiple multiplexed packets received over the satellite communications network.

17. The computer-readable storage medium of claim 16, wherein the method further comprises postprocessing the buffered multiple multiplexed packets to produce a plurality of single synchronized frames for remote inspection.

18. The computer-readable storage medium of claim 17, wherein postprocessing further comprises counting frames.

19. The computer-readable storage medium of claim 17, wherein postprocessing further comprises synchronizing frames.

20. The computer-readable storage medium of claim 15, wherein the method further comprises simultaneously displaying a plurality of channels on a single output device.

21. The computer-readable storage medium of claim 15, further comprising remote video encoding and transmission via a data transmission protocol that combines a number of video channels and manipulating video data to be issued over a network by combining and compressing data packets for transport as a single frame for transmission over a limited bandwidth connection via a regular node stream encode/decode technique.

22. The computer-readable storage medium of claim 15, further comprising converting a NAV string to a video overlay and encoding the video overlay for transport and reassembly by passing data into a streaming decoder, and transmitting, decoding.

23. The computer-readable storage medium of claim 15, further comprising preprocessing video streams and taking all frames in one cycle at a time, timed with corresponding frames using only one encoder so a time between a single threaded video all happens in same CPU cycle(s) as synchronous data capture.

24. The computer-readable storage medium of claim 15, further comprising assessing motion and referencing to previous frames to determine the best output for the lowest bitrate and optimize the video based on input feeds, wherein the data is packetized with only one descriptor.

25. The computer-readable storage medium of claim 15, further comprising when a video packet is received, splitting the video packet back out into separate streams so that the user can view any of the video streams on any output device with only a single instance of decoding.
